(19) United States
(12) Patent Application Publication
(10) Pub. No.: US 2017/0016475 A1
(43) Pub. Date: Jan. 19, 2017

(54) Plain Bearing Shell and Piston For A Radial Piston Engine

(71) Applicant: Ks gleitlager GMbH, St. Leon-Rot (DE)

(72) Inventors: Heger Peter, St. Leon-Rot (DE); Stefan Haecker, Ubstadt-Weiher (DE); Thorsten Stadler, St. Leon-Rot (DE); Hermann Bahm, Oestringen (DE); Nelly Cesar, Ubstadt-Weiher (DE)

(73) Assignee: KS gleitlager GMbH, St. Leon-Rot (DE)

(21) Appl. No.: 15/122,028

(22) PCT Filed: Feb. 25, 2015
(86) PCT No.: PCT/EP2015/053904

§ 371 Date: Aug. 26, 2016

(30) Foreign Application Priority Data
Feb. 27, 2014 (DE) 10 2014 203 571.6

(51) Int. Cl. F16C 9/04; F16C 17/02; F16J 1/14

(52) U.S. Cl. CPC F16C 9/04; F16J 1/14; F16C 17/022; F16C 2360/22; F16C 2220/82

(57) ABSTRACT

The invention relates to a plain bearing shell (2), having a substantially semicylindrical geometry, for use in a piston (50) of a radial piston engine for the purposes of mounting a roller or shaft, having an axial direction (4), a radial direction (6) and a circumferential direction (8) of the plain bearing shell, having two face sides (10, 12) which face away from one another in the axial direction (4), having a radially outer side (14) and a radially inner side (16) which faces toward the roller or shaft and which receives said roller or shaft such that it can slide in the circumferential direction (8); it is proposed according to the invention that, on at least one face side (10, 12), there is provided a projection (18) which protrudes in the axial direction (4) of the plain bearing shell and which serves to form a means for preventing rotation in the circumferential direction (8).

### BACKGROUND OF THE INVENTION

The invention relates to a plain bearing shell having a substantially semicylindrical geometry for use in a piston of a radial piston engine for the purposes of mounting a roller or shaft, having an axial direction, a radial direction, and a circumferential direction of the plain bearing shell, having two face sides that face away from one another in the axial direction, having a radially outer side and a radially inner side which faces toward the roller or shaft and receives said roller or shaft such that it can slide in the circumferential direction.

With such plain bearing shells or such pistons for a radial piston engine, the problem consistently arises of holding the plain bearing shell securely, in particular secure against rotation and substantially reliably in a secure fit on the piston of the radial piston engine. This has been realized to date by forming a projection from the piston material in the region of the circumferential ends of the bearing shell against which the circumferential ends of the inserted, in particular snapped-in, bearing shell basically at least almost rests, for example according to WO 2007/113449 A1. In addition, the bearing shell is frequently also press-fit in a clamping manner for which stamping and/or pressing procedures must be performed on the bearing shell arranged on the piston, which is also involved and can also impair the dimensional stability of the bearing shell as well as the piston. In DE 10 2010 055 073 A1 by the applicant, the suggestion was also made to weld the plain bearing shell radially to the outside to the metal material of the piston.

The object of the present invention is to create another option for a reliably and non-rotatably arranging of a plain bearing shell in a piston of a radial piston engine.

### SUMMARY OF THE INVENTION

This object is achieved according to the invention with a plain bearing shell of the aforementioned type by providing, on at least one face side, a projection that extends in the axial direction of the plain bearing shell to form an anti-rotation element in the circumferential direction with reference to the piston. In the arrangement of a plain bearing shell designed according to the invention, the piston can be designed to be complementary to the axial projection of the plain bearing shell such that it forms a stop which acts in the circumferential direction, or a stop surface for the projection such that the plain bearing shell cannot rotate in its circumferential direction when it is arranged in its proper installation position in a bearing seat recess of the piston. The plain bearing shell according to the invention can have at least one such projection protruding in the axial direction on one or both face sides. If a projection is provided on each face side, the projections can be arranged offset from each other in the circumferential direction, which can ensure a correct installation orientation for the plain bearing shell when the piston is correspondingly designed.

The two face sides of the plain bearing shell can for example be formed by end surfaces of the plain bearing shell which are parallel to each other and from which the projection protrudes axially. It would be at least theoretically conceivable to attach an axial projection by means of a welded or soldered joint on the region of a face side of a plain bearing shell. However, an embodiment is preferred in which the projection is formed integrally from material, in particular the composite layer material of the plain bearing shell. It can prove to be advantageous if the projection extends flush radially to the inside and radially to the outside without a step to the radially inner side and the radially outer side of the plain bearing shell. This can for example be realized by contouring the plain bearing shell from a planar flat material together with the projection, and subsequently transforming it into its substantially semicylindrical geometry in a bending/rolling process.

It would also be conceivable, and in a certain sense advantageous if the projection is formed integrally from material, in particular composite layer material of the plain bearing shell, although deviating from the substantially semicylindrical geometry of the plain bearing shell in that the projection is partially sheared off of the plain bearing shell. This makes it possible to dissociate the projection from the substantially semicylindrical geometry of the plain bearing shell. The projection can thus be adapted to an easy-to-produce geometry of the piston with which it is to interact after all. In particular, it is then possible for the projection to obtain flat side surfaces that are parallel to each other.

In realizing this inventive concept, it can prove to be advantageous if the projection is partially sheared off of the plain bearing shell by a die cut extending in the circumferential direction. Furthermore, it can prove to be advantageous if the projection is partially sheared off of the plain bearing shell by two die cuts extending in the circumferential direction, and remains integrally connected to the plain bearing shell via a central connecting region. It has proven to be advantageous if the central connecting region has a circumferential length of at least the wall thickness (S₃) of the plain bearing shell.

As mentioned, it can prove to be advantageous if the projection has side edges facing away from each other in a circumferential direction which have flat side surfaces which are parallel to each other.

It can however also prove to be advantageous if the projection has side edges, which face away from one another in the circumferential direction and which have flat side surfaces, and the flat side surfaces are oriented in a radial plane of the plain bearing shell and enclose an angle of 10°-50°.

According to another particularly advantageous inventive concept, it is proposed that the projection has side edges, which face away from one another in the circumferential direction and transition via a material notch into the end surface of the relevant face side of the plain bearing shell. This notch prevents having to expend a major effort in the production of a very sharp transition between the side edges in the relevant end surface of the plain bearing shell. If this transitional area is freely cut, the bearing seat recess can be adapted rather precisely to the width of the plain bearing shell so that the end surfaces of the plain bearing shell are supported in the axial direction on both sides by wall regions of the piston. Nonetheless, the projection can be supported in the circumferential direction at least almost without play by stop regions of the piston in the circumferential direction and thereby secured against rotation.

It has proven to be advantageous and useful if the projection has a maximum circumferential length (b) that is 0.1 to 0.4 times the outer diameter of the plain bearing shell.

It has furthermore proven to be advantageous if the projection protrudes at least 2 mm beyond an end surface of the plain bearing shell in the axial direction.

It has furthermore proven to be advantageous if an axial overhang of the projection over an end surface of the plain bearing shell satisfies the following formula:

$$l \leq \sqrt{\frac{{D}^{2} + {B}^{2}}{4} - \frac{{b}^{2}}{4}} - \frac{B}{2}$$

where D designates the bearing shell outer diameter, B designates the bearing shell width in the axial direction, and b designates the maximum circumferential length of the projection.

Furthermore, protection is claimed for a piston for a radial piston engine having the features of claims 15 and 16 respectively.

### BRIEF DESCRIPTION OF THE DRAWINGS

Additional features, details and advantages of the invention are found in the patent claims, graphical representation and subsequent description of preferred embodiments of the invention. In the drawings:

FIGS. 1 to 5 show different perspective views of embodiments of plain bearing shells according to the invention

FIG. 6 shows a perspective view of a schematically represented piston of a radial piston engine with a plain bearing shell according to the invention arranged in the piston's bearing seat recess.

### DETAILED DESCRIPTION

In the figures, plain bearing shells designed according to the invention are consistently designated by reference number 2. The respective plain bearing shell 2 always comprises an axial direction 4, a radial direction 6 and a circumferential direction 8. It comprises two face sides 10, 12 facing away from each other in the axial direction 4, as well as a radially outer side 14 and a radially inner side 16. According to the invention, a projection 18 extending in the axial direction 4 is formed on at least one face side 10, 12 and, in the preferred depicted case, on each face side 10, 12. The respective projection 18 only protrudes in the axial direction 4 beyond an end surface 20, 22 forming a respective face side 10, 12. In all embodiments, the projection 18 is formed integrally from the material, or composite layer material, of the plain bearing shell 2. At least in one connecting region 24 yet to be explained, the projection 18 preferably transitions step-free radially to the outside and radially to the inside into the radially outer and radially inner side 14, 16 respectively of the plain bearing shell 2.

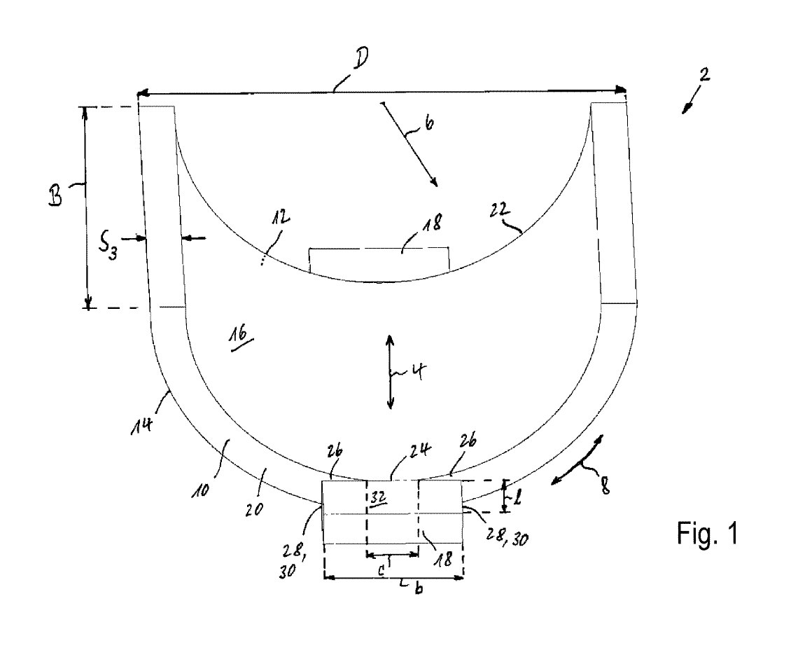

In the exemplary embodiment in FIG. 1, the projection 18 deviates from the basically semicylindrical geometry of the plain bearing shell 2. Whereas the other plain bearing shell 2 was shaped into a basically semicylindrical shape in a bending/rolling process, the projection 18 was partially sheared off of the semicylindrical part of the plain bearing shell 2 at cutting surfaces 26. It is thereby possible for the projection 18 to assume, for example, a substantially rectangular shape as shown in FIG. 1. It is furthermore thereby possible for the projection to have side edges 28 that face away from one another in the circumferential direction 8 and form flat side surfaces 30 which are parallel to one another. The respective plane of the side surfaces 30 therefore does not extend in a radial plane of the plain bearing shell but rather orthogonally to the original flat material, i.e. to the inner and outer surface 32 of the projection 18.

If the flat side surfaces 30 are parallel to each other, a recess configured to be complementary thereto can be easily formed for a piston for a radial piston engine; for example, it is sufficient in this case if a slot extending in the longitudinal direction of the piston is formed in the piston skirt with a width that corresponds to the spacing of the side surfaces 30 from each other.

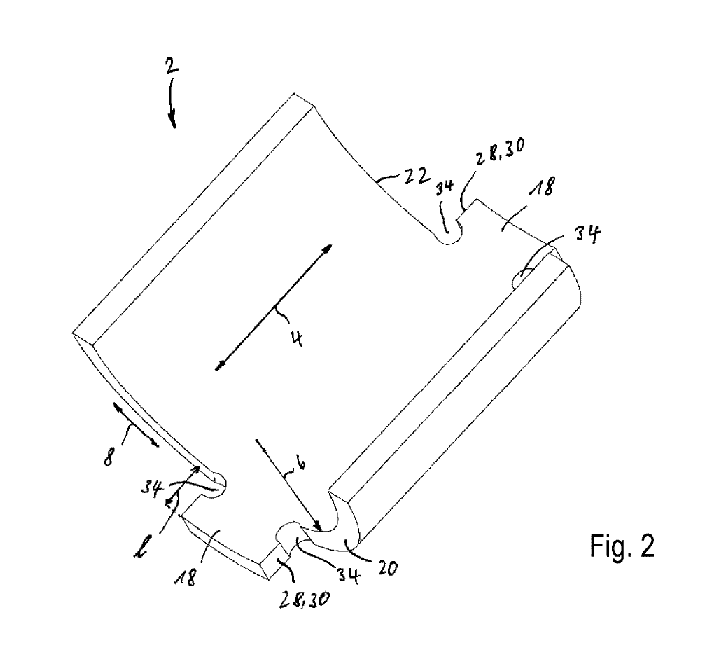

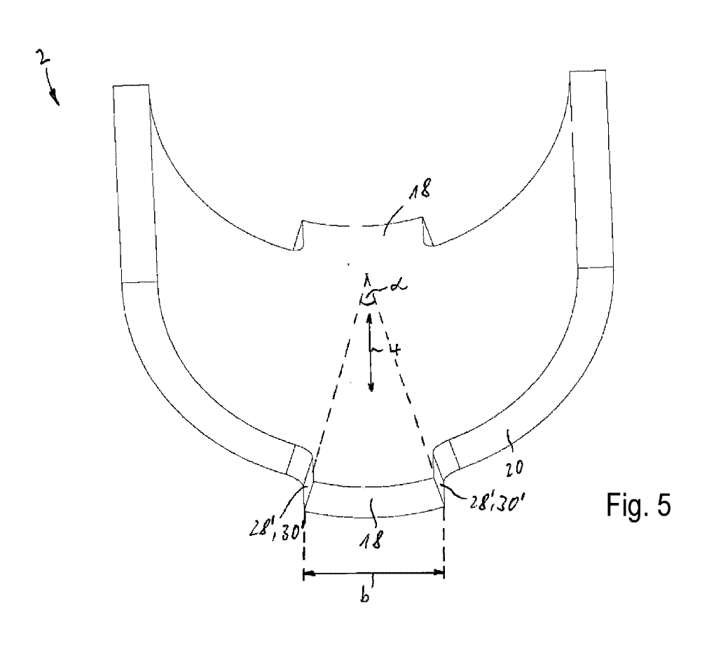

The connecting region 24 has an extension in the circumferential direction 8 (projected onto a plane) of c, where c is greater than or equal to the wall thickness S₃. The maximum circumferential extension or width of the respective projection 18 is projected onto a plane designated b as an example in FIGS. 1 and 5. The axial length or depth of the projection 18 is designated I in FIGS. 1 and 2.

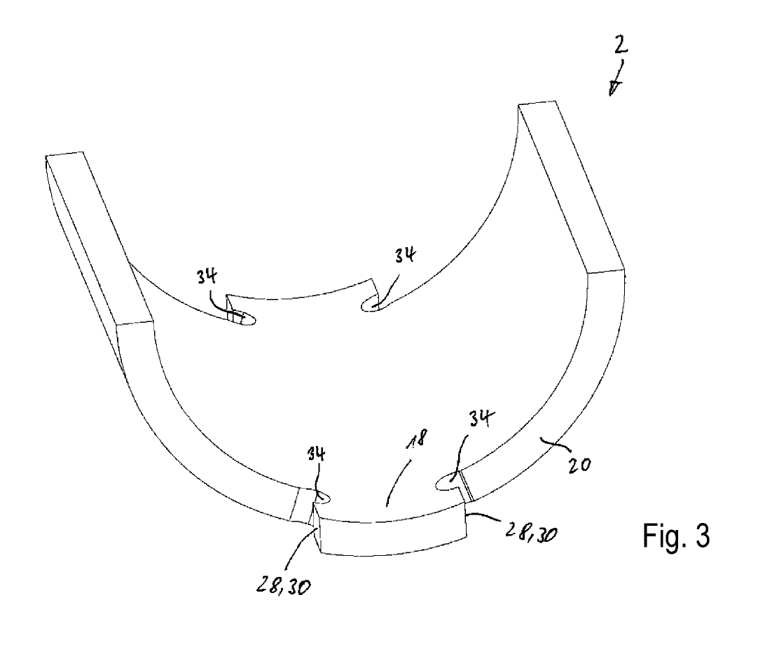

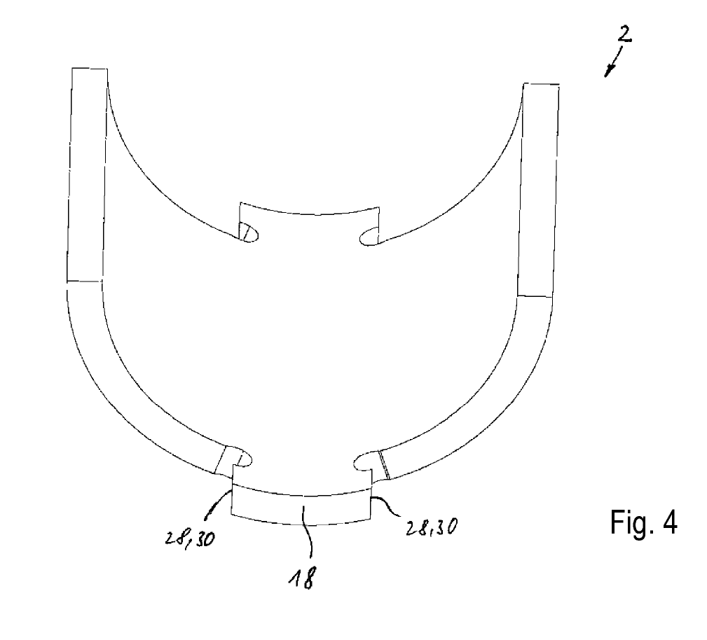

FIGS. 2, 3 and 4 show another embodiment of a plain bearing shell 2 according to the invention. In this plain bearing shell 2, the projection 18 as well as the cylindrical part of the plain bearing shell is shaped into a substantially semicylindrical geometry. Nonetheless, the side edges 28 are processed so that their flat side surfaces 30 are parallel to each other.

A material notch 34 that extends approximately in the radial direction 6 is respectively provided at the transition of the side edges 28 to the end surfaces 20, 22 of the plain bearing shell 2. This makes it easier to form a recess in the piston which holds the projection 18 against rotation. The notch 34 can for example be created by machining or with a die cut, in particular when forming the projection 18 in particular by punching.

Finally, FIG. 5 shows a plain bearing shell 2 according to the invention with a projection 18 that protrudes in the axial direction 4 beyond a respective end surface 20. The side edges 28′ are not parallel to each other. They are formed by flat side surfaces 30′. These flat side surfaces 30′ however enclose an acute angle α.

The respective notch 34 in the plain bearing shells has, at least in sections, a curvature radius R which ranges from 0.5 to 2.5 times the wall thickness S₃ of the bearing shell.

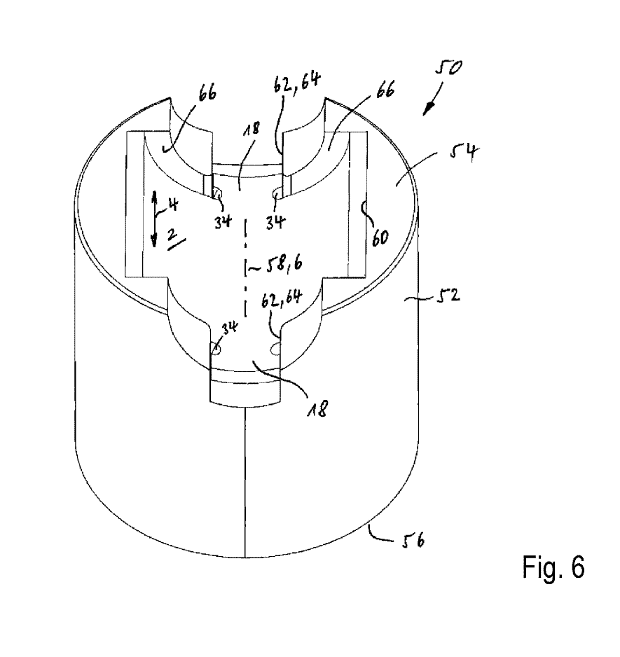

Finally, FIG. 6 shows a piston 50 for a radial piston engine. The piston comprises one piston skirt 52, two axial ends 54, 56, and one longitudinal piston axis 58. At one end 54 of the piston, a semicylindrical bearing seat recess is provided, which is consistently designated by reference number 60. A plain bearing shell 2 according to the invention is inserted into this bearing seat recess 60 such that the longitudinal piston axis 58 extends through a middle peak of the plain bearing shell 2 in the radial direction 6 of the plain bearing shell 2. It can be seen that the projections 18 on both sides, for example, engage with slotted recesses 62, which extend in the piston skirt 52 in the direction of the longitudinal piston axis 58. These slotted recesses 62 are bounded by, for example, flat wall sections 64 that at least essentially lie almost completely against the side edges 28 of the respective projection and thereby form an anti-rotation element for the plain bearing shell 2 in the circumferential direction.

Furthermore, the piston 50 is for example designed such that the plain bearing shell is held in a specific position and substantially without play in the axial direction 4 by lateral faces 66 of the piston. It would also be conceivable for these lateral faces 66 to not protrude beyond the inner side of the plain bearing shell in the radial direction 6 so that the mounting of a shaft would also be conceivable.

In a manner known per se, the plain bearing shell 2 accommodates a roller (not shown) which can roll against a cam track radially to the outside in a radial piston engine, wherein the piston is moved back and forth in its radial arrangement. It is, however, noted that the drive direction can in principle be reversed in radial piston engines.

1. A plain bearing shell (2) with a substantially semicylindrical geometry for use in a piston (50) of a radial piston engine for the purposes of mounting a roller or shaft, having an axial direction (4), a radial direction (6), and a circumferential direction (8) of the plain bearing shell, comprising two face sides (10, 12) that face away from one another in the axial direction (4), a radially outer side (14) and a radially inner side (16) which faces the roller or shaft and receives said roller or shaft such that it can slide in the circumferential direction (8), characterized in that on at least one face side (10, 12), a projection (18) that protrudes in the axial direction (4) of the plain bearing shell is provided to form an anti-rotation element in the circumferential direction (8).

2. The plain bearing shell according to claim 1, characterized in that the two face sides (10, 12) are formed by end surfaces (20, 22) of the plain bearing shell which are parallel to one another and from which the projection (18) protrudes axially.

3. The plain bearing shell according to claim 1, characterized in that the projection (18) is formed integrally from material, in particular the composite layer material of the plain bearing shell.

4. The plain bearing shell according to claim 1, characterized in that the projection (18) extends flush radially to the inside and radially to the outside without a step to the radially inner side (16) and the radially outer side (14) of the plain bearing shell.

5. The plain bearing shell according to claim 1, characterized in that the projection (18) is formed integrally from material, in particular composite layer material of the plain bearing shell, although deviating from the substantially semicylindrical geometry of the plain bearing shell in that the projection (18) is partially sheared off of the plain bearing shell.

6. The plain bearing shell according to claim 1, characterized in that the projection (18) is partially sheared off of the plain bearing shell by a die cut extending in the circumferential direction.

7. The plain bearing shell according to claim 6, characterized in that the projection (18) is partially sheared off of the plain bearing shell by two die cuts extending in the circumferential direction, and remains integrally connected to the plain bearing shell via a central connecting region (24).

8. The plain bearing shell according to claim 6, characterized in that the in particular central connecting region (24) has a circumferential length of at least the wall thickness (S₃) of the plain bearing shell.

9. The plain bearing shell according to claim 1, characterized in that the projection (18) has side edges (28) that face away from one another in the circumferential direction (8) and have side surfaces (30) that are parallel to one another and preferably flat.

10. The plain bearing shell according to claim 1, characterized in that the projection (18) has side edges (28) that face away from one another in the circumferential direction (8) which preferably have flat side surfaces (30), and the preferably flat side surfaces (30) are oriented in a radial plane of the plain bearing shell and enclose an angle of 10°-50°.

11. The plain bearing shell according to claim 1, characterized in that the projection (18) has side edges (28) which face away from one another in the circumferential direction (8) and transition via a material notch into the end surface (20, 22) of the relevant face side (10, 12) of the plain bearing shell.

12. The plain bearing shell according to claim 1, characterized in that the projection (18) has a maximum circumferential length (b) that is 0.1 to 0.4 times the outer diameter (D) of the plain bearing shell.

13. The plain bearing shell according to claim 1, characterized in that the projection (18) protrudes at least 2 mm beyond an end surface (20, 22) of the plain bearing shell in the axial direction (4).

14. The plain bearing shell according to claim 1, characterized in that an axial overhang (1) of the projection (8) over an end surface (20, 22) of the plain bearing shell satisfies the following formula:
$$l \leq \sqrt{\frac{{D}^{2} + {B}^{2}}{4} - \frac{{b}^{2}}{4}} - \frac{B}{2}$$
where D designates the bearing shell outer diameter, B designates the bearing shell width in the axial direction, and b designates the maximum circumferential length of the projection (18).

15. A piston (50) for a radial piston engine comprising a longitudinal piston axis (58) extending in the direction of movement of the piston during operation, two axial ends (54, 56) and a piston skirt (52), an approximately semicylindrical metal plain bearing shell (2) according to one or more of the preceding claims, which is arranged at an end (54) in a bearing seat recess (60), for rotatably receiving a roller or shaft, wherein the axial direction (4) of the plain bearing shell (2) and the roller or shaft extend orthogonally to the longitudinal piston axis (58), wherein the piston has regions (64) that form an anti-rotation element in the circumferential direction (8) of the plain bearing shell (2) in that they form a stop acting in the circumferential direction (8) for the projection (18).

16. The piston according to claim 15, characterized in that the regions (64) are formed by a recess (62) in the piston skirt (52) extending in the direction of the longitudinal piston axis (58).
